(19) United States
(12) Patent Application Publication
(10) Pub. No.: US 2008/0225840 A1
(43) Pub. Date: Sep. 18, 2008

(54) VOIP system

(75) Inventors: Bor-Wen Yang, Taipei County (TW); Tan-Chun Lu, Taipei County (TW); Li-lu Chen, Taipei City (TW)

Correspondence Address: BIRCH STEWART KOLASCH & BIRCH, PO BOX 747, FALLS CHURCH, VA, 22040-0747, US

(73) Assignee: Accton Technology Corporation

(21) Appl. No.: 11/724,203

(22) Filed: Mar. 15, 2007

(51) Int. Cl. H04L 12/28

(52) U.S. Cl. 370/389; 370/351

(57) ABSTRACT

A Voice over Internet Protocol (VOIP) system cooperates with a phone and an access point storing default connecting information. The VOIP system includes a transmitting module, a receiving module, a decoding module and a comparing module. The transmitting module is disposed in the phone and transmits numeral information. The receiving module is disposed in the access point and receives the numeral information. The decoding module is disposed in the access point and is electrically connected with the receiving module for converting the numeral information into character information. The comparing module is disposed in the access point and is electrically connected with the decoding module for comparing the character information and the default connecting information so as to determine whether the access point proceeds to connect with the phone or not.

### BACKGROUND OF THE INVENTION

1. Field of Invention

The invention relates to a network system and, in particular, to a Voice over Internet Protocol (VOIP) system.

2. Related Art

With the rapid development in network technology, people are able to transmit a huge amount of multimedia information over the network. Voice over Internet Protocol (VOIP) is such a technology for transmitting voice information between different network nodes.

As shown in FIG. 1, a conventional network phone system 1 includes an access point 11 and a phone 12. The access point 11 comes pre-programmed with a default character code 21 consisting of several alphabets and numerals. Moreover, the default character code 21 can be a service set identifier (SSID).

When the phone 12 is to establish a connection with the access point 11, the user has to use the phone 12 to enter a character code 22 consisting of several alphanumeric characters. The phone 12 then transmits the character code 22 to the access point 11. Finally, the access point 11 compares the default character code 21 with the character code 22 entered by the user to determine whether to establish the connection with the phone 12.

Generally speaking, a phone 12 has the number keys 0-9. Using a phone 12 to enter the numerals in the character code 22 is relatively easy. The user simply presses the number keys thereon. However, to enter non-numeric characters in the character code 22 using a phone 12 is inconvenient. This is because a non-numeric character is selected via a combination of number keys and a specific input method. This increases the time required for entering the character code 22.

Therefore, it is very useful to provide an easier input method for the VOIP system to establish the connection between a phone and an access point.

### SUMMARY OF THE INVENTION

In view of the foregoing, the invention is to provide a VOIP system that allows the user to enter exclusively numerals on a phone to establish the connection between the phone and an access point.

To achieve the above, the invention discloses a VOIP system cooperating with a phone and an access point, which stores default connecting information. The VOIP system includes a transmitting module, a receiving module, a decoding module and a comparing module. The transmitting module is disposed in the phone and transmits numeral information. The receiving module is disposed in the access point and receives the numeral information. The decoding module is disposed in the access point and is electrically connected with the receiving module for converting the numeral information into character information. The comparing module is disposed in the access point and is electrically connected with the decoding module for comparing the character information and the default connecting information so as to determine whether the access point proceeds to connect with the phone or not.

As mentioned above, the VOIP system of the invention converts numeral information into character information and compares the character information with the default connecting information so as to determine whether the access point proceeds to connect with the phone or not. In other words, the user only needs to enter the numeral information using the phone in order to establish the connection between the phone and the access point. This avoids the difficulty of entering alphabetic characters using a phone.

### BRIEF DESCRIPTION OF THE DRAWINGS

The invention will become more fully understood from the detailed description given herein below illustration only, and thus is not limitative of the present invention, and wherein:

FIG. 1 is a schematic view of a conventional VOIP system;

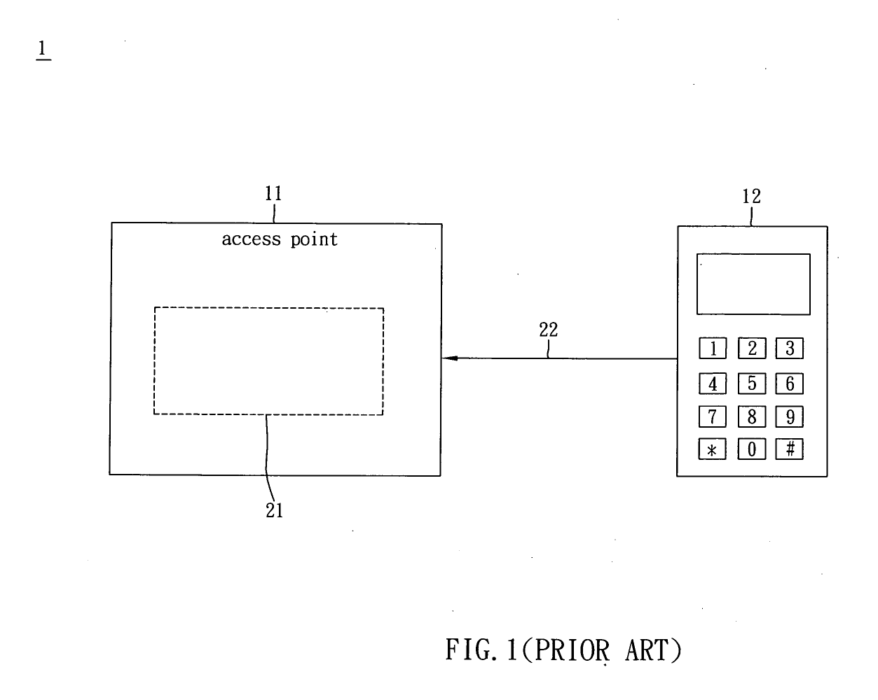

FIG. 2 is a schematic view of the VOIP system according to a preferred embodiment of the invention; and

FIG. 3 is another schematic view of the VOIP system according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

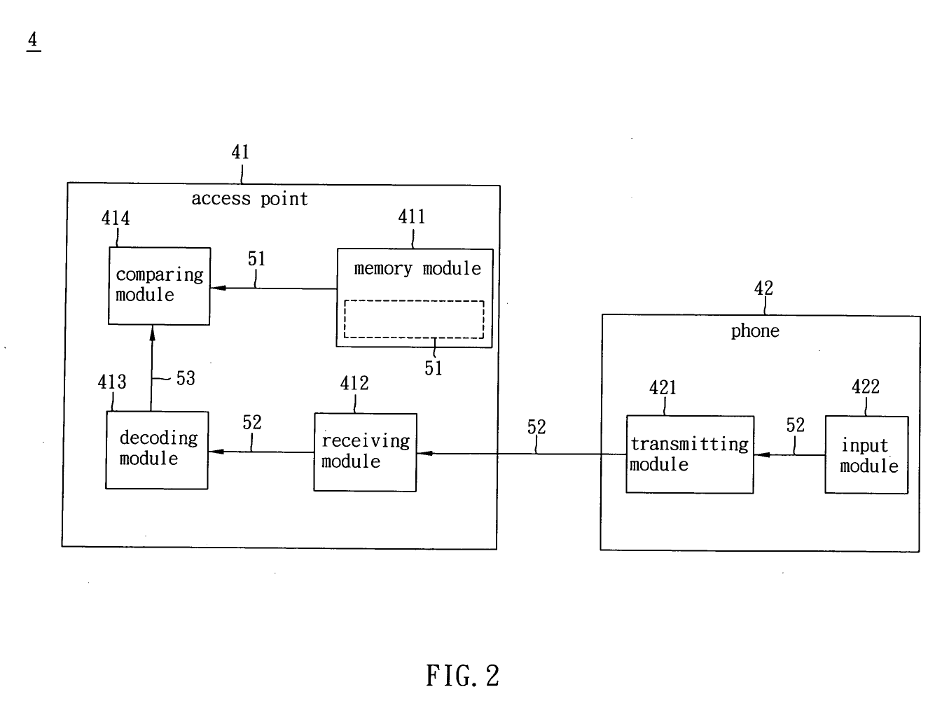

As shown in FIG. 2, a VOIP system 4 according to the preferred embodiment of the invention operates among an access point 41 and a phone 42. The access point 41 stores default connecting information 51. In this embodiment, the default connecting information 51 is pre-stored in a memory module 411 of the access point 41.

The VOIP system 4 includes a receiving module 412, a decoding module 413, and a comparing module 414 disposed in the access point 41 and a transmitting module 421 disposed in the phone 42.

The transmitting module 421 in the phone 42 transmits numeral information 52. In practice, the numeral information 52 can contain information such as network verification or encryption passwords. In this embodiment, the network verification can be a service set identifier (SSID), and the encryption password can be a wired equivalent privacy (WEP). Moreover, the phone 42 further includes an input module 422 electrically connected with the transmitting module 421. In this case, the user can enter the numeral information 52 into the phone 42 via the input module 422 and send the numeral information 52 to the transmitting module 421. Generally speaking, the input module 422 may include a numeral keypad or a set of numeral buttons.

The receiving module 412 in the access point 41 receives the numeral information 52. The decoding module 413 is electrically connected with the receiving module 412 and converts the numeral information 52 into character information 53. The character information 53 consists of at least one alphabetic character and at least one numeral to represent the network verification or encryption password corresponding to the numeral information 52. In this embodiment, the character information is in accord with the American Standard Code for Information Interchange (ASCII).

The comparing module 414 is electrically connected with the decoding module 413 and the memory module 411, and compares the character information 53 with the default connecting information 51 for the access point 41 to determine whether to establish a connection with the phone 42. The default connecting information 51 consists of at least one alphabetic character and at least one numeral, and may include a network verification or encryption password for the connection according to needs. In this embodiment, the comparing module 414 compares the character information 53 with the default connecting information 51 and generates a comparison result accordingly. If the comparison result indicates that the character information 53 is the same as the default connecting information 51, the access point 41 and the phone 42 can establish a connection.

According to the current embodiment, the information transmission between the transmitting module 421 in the phone 42 and the receiving module 412 in the access point 41 can be wired or wireless.

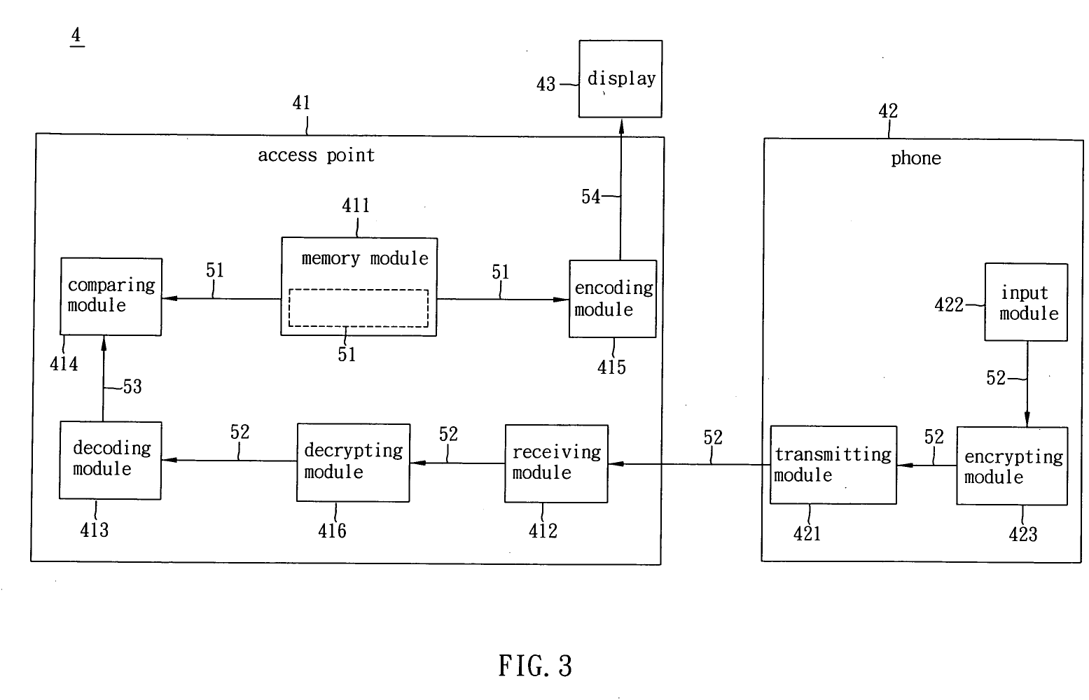

Please refer to FIG. 3. In this embodiment, the access point 41 further includes an encoding module 415 for converting the default connecting information 51 into default numeral information 54. The VOIP system 4 also includes a display 43 disposed in either the access point 41 or the phone 42 (not shown). Of course, the display 43 can be independently provided (as shown in FIG. 3). The display 43 is electrically connected with the encoding module 415 of the access point 41 and shows the default numeral information 54 produced by the encoding module 415 of the access point 41. In this case, the user can obtain the default numeral information 54 from the display 43, and enters the numeral information 52 via the input module 422 of the phone 42 accordingly. The connection between the display 43 and the access point 41 can be wired or wireless.

In accord with the current embodiment, the VOIP system 4 can further include an encrypting module 423 and a decrypting module 416 for the actual network information transmission security. The encrypting module 423 is disposed in the phone 42 and electrically connected with the transmitting module 421. The decrypting module 416 is disposed in the access point 41 and electrically connected with the receiving module 412. The encrypting module 423 receives the numeral information 52 from the input module 422, encrypts the numeral information 52, and transfers it to the transmitting module 421. The decrypting module 416 receives the numeral information 52 from the receiving module 412, decrypts the numeral information 52, and transmits it to the decoding module 413. This mechanism can increase the security of information transmission between the phone 42 and the access point 41.

In summary, the VOIP system of the invention converts numeral information into character information and compares the character information with the default connecting information so as to determine whether the access point proceeds to connect with the phone or not. In other words, the user only needs to enter the numeral information using the phone in order to establish the connection between the phone and the access point. This avoids the difficulty of entering alphabetic characters using a phone.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A Voice over Internet Protocol (VOIP) system cooperating with a phone and an access point storing default connecting information, the system comprising:
a transmitting module, which is disposed in the phone for transmitting numeral information;
a receiving module, which is disposed in the access point for receiving the numeral information;
a decoding module, which is disposed in the access point and electrically connected with the receiving module for converting the numeral information into character information; and
a comparing module, which is disposed in the access point and electrically connected with the decoding module for comparing the character information and the default connecting information so as to determine whether the access point proceeds to connect with the phone or not.

2. The VOIP system of claim 1, wherein the character information at least comprises an alphabetic character and a numeral.

3. The VOIP system of claim 1, wherein the character information or the numeral information comprises a service set identifier (SSID).

4. The VOIP system of claim 1, wherein the character information or the numeral information comprises a wired equivalent privacy (WEP).

5. The VOIP system of claim 1, wherein the transmission between the transmitting module of the phone and the receiving module of the access point is wireless.

6. The VOIP system of claim 1 further comprising:
an encrypting module, which is disposed in the phone and electrically connected with the transmitting module for encrypting the numeral information and transferring it to the transmitting module; and
a decrypting module, which is disposed in the access point and electrically connected with the receiving module for decrypting the numeral information and transferring it to the decoding module.

7. The VOIP system of claim 1, wherein the phone further comprises an input module electrically connected with the transmitting module, and the numeral information is transmitted by the input module to the transmitting module.

8. The VOIP system of claim 7, wherein the input module is a numeral keypad.

9. The VOIP system of claim 1, wherein the character information is in accord with the American Standard Code for Information Interchange (ASCII).

10. The VOIP system of claim 1 further comprising:
an encoding module, which is disposed in the access point for converting the default connecting information into default numeral information.

11. The VOIP system of claim 10 further comprising:
a display for showing the default numeral information generated by the encoding module of the access point.

12. The VOIP system of claim 11, wherein the transmission between the display and the access point is wireless.
